(19) United States
(12) Patent Application Publication
(10) Pub. No.: US 2005/0021592 A1
(43) Pub. Date: Jan. 27, 2005

(54) Notification of subscriber status in a communications network

(76) Inventors: Sandeep Patel, London (GB); Ricky Kaura, Uxbridge (GB)

Correspondence Address: BARNES & THORNBURG, P.O. BOX 2786, CHICAGO, IL, 60690-2786, US

(21) Appl. No.: 10/620,274

(22) Filed: Jul. 11, 2003

(51) Int. Cl. G06F 15/16

(52) U.S. Cl. 709/200

(57) ABSTRACT

The application is directed to a methods and apparatus for intelligent network service provision, in particular in a wireless network. The method comprises the steps of: storing network user status information at a first network element; receiving at the first network element a message from a second network element, said message associated with a change in network user status information; updating said stored information; and providing services to said network user dependant on said network user status information. This enables a network user to receive the services to which he is entitled without interruption when the user's identity code changes, for example when a SIM card is replaced. It further enables efficient use of network resources by prevention of signalling to users who are no longer entitled to receive certain services.

### FIELD OF THE INVENTION

This invention relates to methods and apparatus for notification of subscriber status in a communications network.

### BACKGROUND TO THE INVENTION

With reference to FIG. 1 there is shown a schematic diagram of a mobile communications network. An end user connects to the network via an end user network element (or terminal) 101 such as a mobile phone. The mobile phone 101 communicates with either a mobile switching centre (MSC) 103 or a serving GPRS support node (SGSN, GPRS=General Packet Radio Service) 102 or both via network elements including a base station (not shown). The MSC handles circuit switched (CS) services, such as voice, and the SGSN handles packet switched (PS) services, such as packet data. The SGSN is responsible, in the packet domain, for packet data context negotiation. Associated with the MSC is a visitor location register (VLR) 104. The VLR stores information on the end user network elements 101 which are located within the coverage area of the MSC, (the end user network elements are also described as being located at the VLR/MSC), and this information is requested by the VLR from the home location register (HLR) 105 when a new network element enters the area (or locates at the VLR/MSC). Corresponding functionality for the packet domain is integrated into the SGSN. The HLR provides a store of user information for all the end users subscribing to that network. The network also comprises one or more service control functions (SCF) 106, which may alternatively be referred to as service control points (SCP). The SCF provides services to the end user via the VLR/MSC or SGSN.

The invention seeks to provide an improved method of service provision in a communications network which mitigates at least one of the problems of known methods.

### SUMMARY OF THE INVENTION

According to a first aspect of the invention there is provided a method of intelligent network service provision by a first network element, comprising the steps of: storing network user status information at said first network element; receiving at the first network element a message from a second network element, said message associated with a change in network user status information; updating said stored information; and providing services to said network user dependant on said network user status information.

An advantage of the present invention is that the network user continues to receive the services to which he is entitled without interruption when the user's identity code changes, for example when a SIM card is replaced.

A further advantage of the present invention is that network resources are not used in attempting to provide services to a network user who is no longer allowed to receive services as they have been deactivated or deleted.

A further advantage of the present invention is that services are automatically re-enabled when a user is activated following deactivation or deletion.

The method may further comprise the step of: at said second network element, sending a message to each of a predetermined set of network elements, said message associated with a change in network user status information, wherein said predetermined set includes said first network element.

An advantage of the use of a predetermined set of network elements is that the network remains in control of which network elements have access to changes in user information. This may be beneficial for security reasons or for commercial reasons.

The method may further comprise the step of: at said second network element, selecting said predetermined set of network elements according to the change in network user status information.

The change in network user status information may be one of user activated, user deactivated, user deleted, user identifier code updated, user service screened and user service suppressed.

The user identifier code may be an international mobile subscriber identity.

The first and second network elements may be wireless network elements.

The first network element may be a service control function.

The second network element may be a home location register.

According to a second aspect of the invention there is provided a computer program for performing the method described above.

The computer program may be stored in machine readable form.

The computer program may be on a storage medium.

According to a third aspect of the invention there is provided a method of sharing network user status information in a communications network, said method comprising the steps of: storing network user status information at a first network element; and sending a message to each of a predetermined set of network elements, said message associated with a change in network user status information.

Each of said predetermined set of network elements may be arranged to provide services to network users.

The method may further comprise the step of: selecting said predetermined set of network elements according to the change in network user status information.

According to a fourth aspect of the invention there is provided a computer program for performing the method described above.

The computer program may be stored in machine readable form.

The computer program may be on a storage medium.

According to a fifth aspect of the invention there is provided a service providing network element comprising: a memory arranged to store network user status information; a receiver arranged to receive a message from a second network element, said message associated with a change in network user status information; a processor arranged to read said message and update said network user status information stored in said memory; and a transmitter arranged to provide services to a network user dependent on said network user status information.

The services may be intelligent network services.

The memory may comprise a database.

According to a sixth aspect of the invention there is provided a network element comprising: a memory arranged to store network user status information; and a transmitter arranged to send a message to each of a predetermined set of service providing network elements, said message associated with a change in network user status information.

The network element may further comprise a selector arranged to select said predetermined set of service providing network elements according to said change in network user status information.

According to a seventh aspect of the invention there is provided a communications network comprising: a service providing network element as described above and a network element as described above.

The network may be a wireless network.

The network may be a cellular mobile network.

Preferred features may be combined as appropriate as would be apparent to a skilled person and may be combined with any of the aspects of the invention.

### BRIEF DESCRIPTION OF THE DRAWINGS

Embodiments of the invention will now be described with reference to the accompanying drawings in which:

FIG. 1 is a schematic diagram of a mobile communications network;

FIG. 2 shows a schematic message flow within the network of FIG. 1;

FIG. 3 shows a schematic message flow within the network of FIG. 1 according to the present invention;

FIG. 4 shows a schematic message flow within the network of FIG. 1;

FIG. 5 shows a schematic message flow within the network of FIG. 1;

FIG. 6 shows a schematic message flow within the network of FIG. 1 according to the present invention;

FIG. 7 shows an example of a message for signalling between the HLR and the SCF according to the present invention; and

FIG. 8 shows an example trigger method for the message of FIG. 7.

Common reference numerals have been used throughout where appropriate.

### DETAILED DESCRIPTION OF THE INVENTION

Embodiments of the present invention are described below by way of example only. These examples represent the best ways of putting the invention into practice that are currently known to the applicant although they are not the only ways in which this could be achieved.

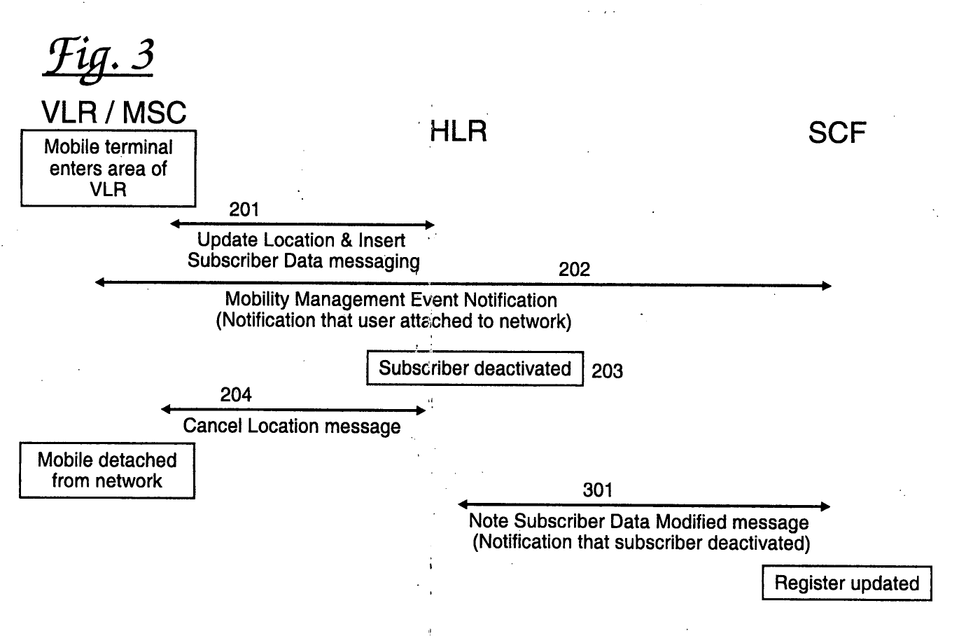

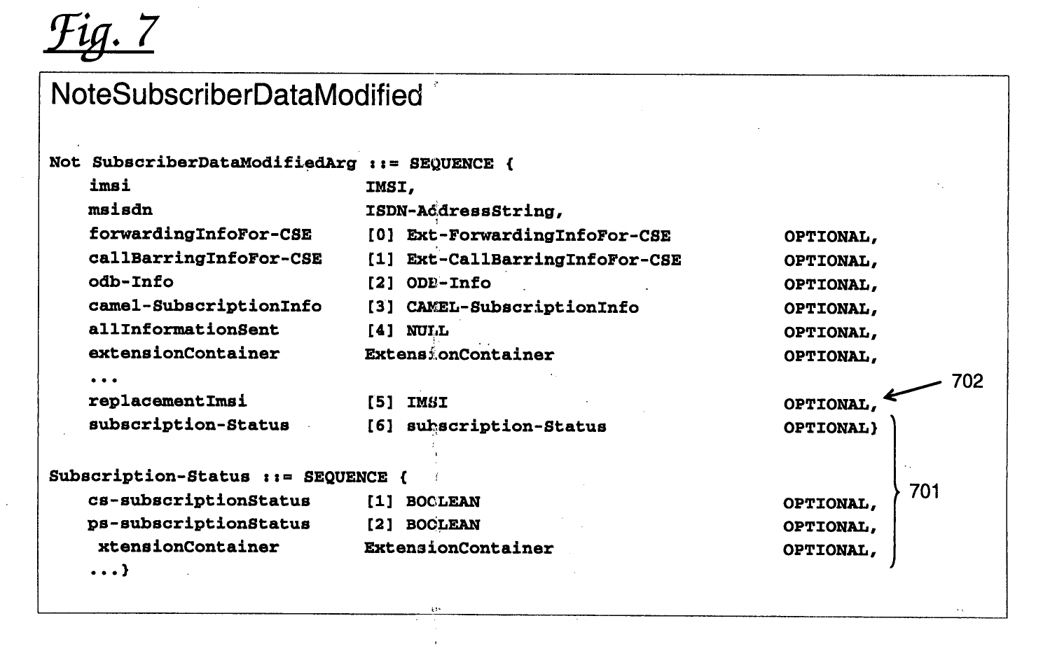

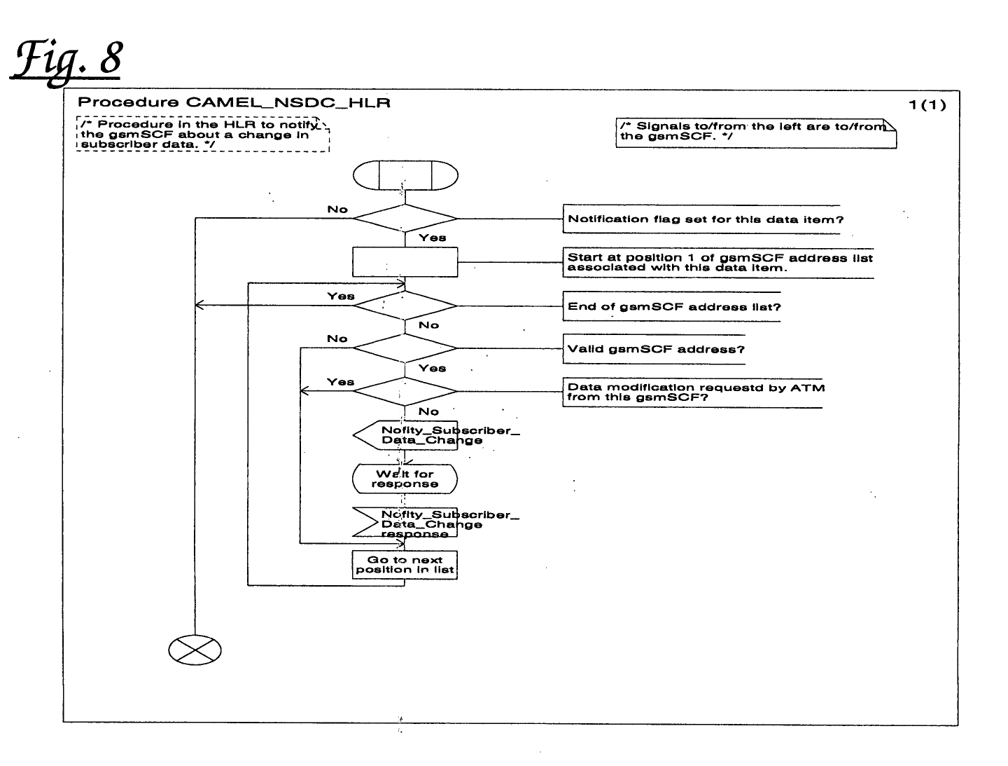

The description herein refers to the circuit switched domain by way of example only. The invention may also be implemented in the packet switched domain where the SGSN performs the functionality which corresponds to the VLR/MSC in the circuit switched domain. The message flows shown in FIGS. 3-6 are equally applicable to the packet domain, where the HLR and SCF communicate with the SGSN rather than the VLR/MSC. The message of FIG. 7 and trigger method of FIG. 8 are also applicable to the packet domain.

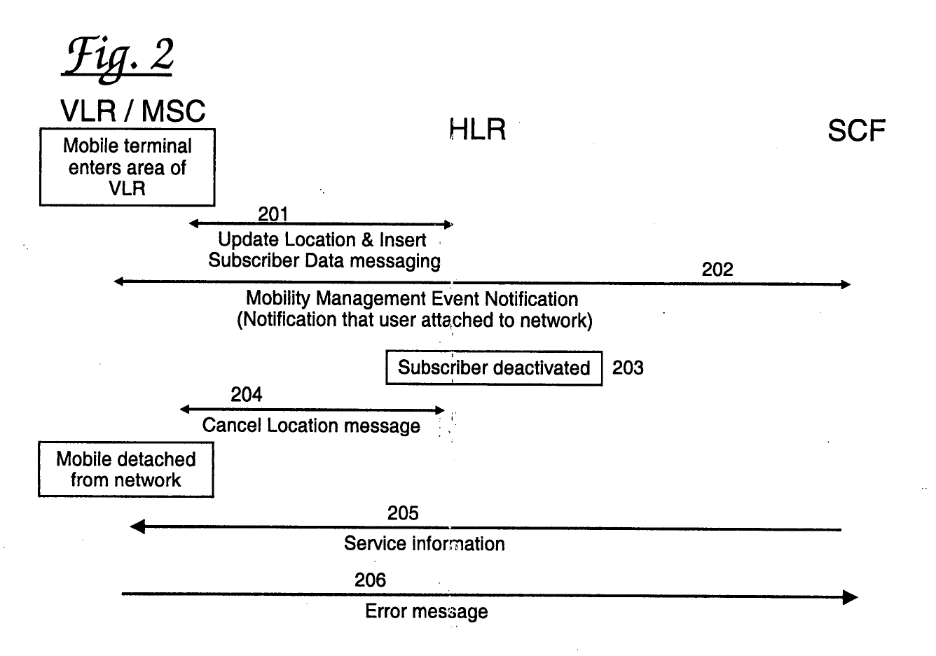

A first example of the invention is described with reference to FIGS. 2 and 3.

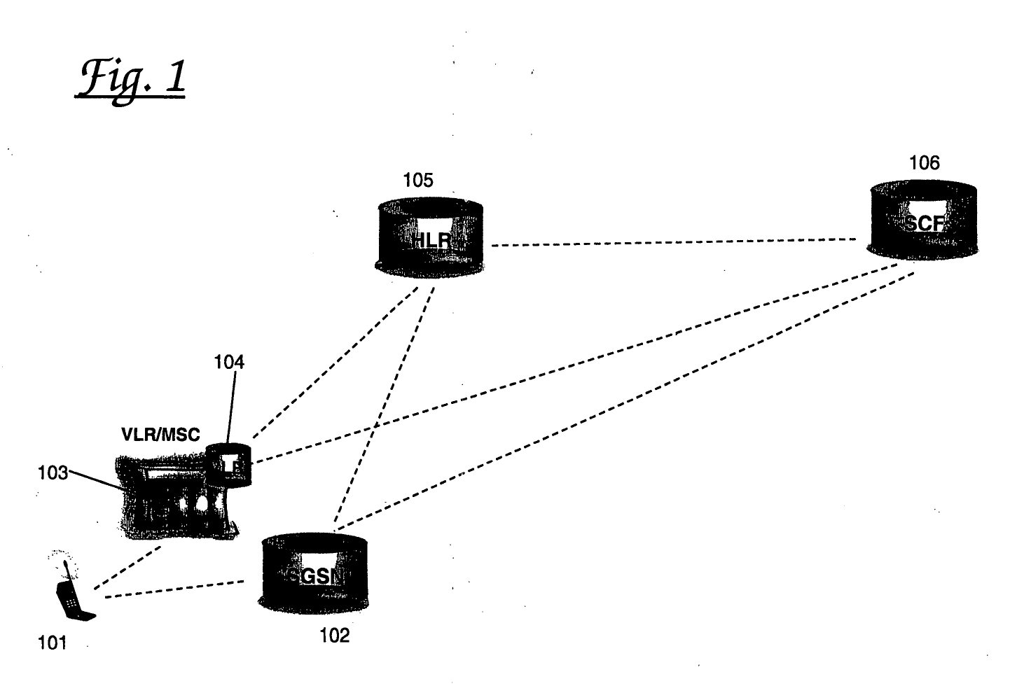

In a mobile communications network, such as that shown in FIG. 1, when a mobile terminal enters the area of the VLR/MSC, the user profile for that end user or subscriber is downloaded from the HLR to the VLR 201, as shown in the schematic message flow in FIG. 2. This user profile may include mobility management CAMEL subscription information (M-CSI) which is held in the HLR (CAMEL=customised applications for mobile enhanced logic). The VLR/MSC then notifies the service control function (SCF) identified in the subscribers M-CSI profile that the particular user has attached to the network 202, (the subscriber's M-CSI profile identifies a single SCF which is notified for mobility management events).

Subsequently the subscriber may be deactivated by the operator 203. This may be caused by many reasons, including but not limited to failure to pay bills, theft of the mobile phone or fraudulent activity. When deactivation occurs the HLR sends a cancel location message 204 to the VLR and the mobile is detached from the network. If the SCF subsequently provides service information to the VLR which is destined to that user 205, the VLR will respond with an error message 206 because the mobile is detached from the network. This may lead to unnecessary signalling since the subscriber is no longer active in the network.

A schematic message flow according to the present invention is shown in FIG. 3.

When the subscriber is deactivated 203 by the operator, in addition to sending a cancel location message from the HLR to the VLR 204 the HLR sends notification that the subscriber has been deactivated 301 to one or more SCFs. SCFs must interpret this message and this enables the notified SCFs to update their registers and to stop activation (or provision) of future services which would be destined for the deactivated user.

The SCF uses service logic, is transaction based and primarily provides intelligent network services, for example prepaid, VPN (Virtual Private Networks) and dialled services.

The network may provide both circuit switched (CS) and packet switched (PS) services such as voice services and data services. In some circumstances the subscriber may be deactivated from only one of these two sets of services. For example, if the subscriber is deactivated from the packet switched service but remains active on the circuit switched services, the HLR will inform the SCF that the subscriber no longer has access to the PS domain and to deactivate the packet switched services only. Subsequently the SCF will stop any packet switched services destined for the user but will pass any circuit switched services such as voice services.

The term ‘deactivation’ is used herein to refer to the situation when the subscriber is not able to make or receive calls (or pass data) and cannot locate at a VLR/MSC (or SGSN). For all purposes the subscriber is treated as if they are unknown to the network. This differs from ‘deletion’ where the subscriber profile is permanently removed from the HLR, however the techniques described herein could also be applied if a subscriber is deleted or if a subscriber status was changed in any manner with the aim of preventing the subscriber having access to some or all services.

When a subscriber is deactivated the operator has the ability to decide which SCFs the HLR will inform of the deactivation. This may be a sub-set of the SCFs (or could be all of them). The sub-set may be selected for reasons of security. For example, the HLR may notify SCFs which are owned by the same operator as the HLR but may choose not to notify SCFs which are run by other service providers or operators (e.g. competing providers or operators). The subscriber information within the HLR may therefore contain two lists of SCFs; the list of SCFs to inform if the subscriber's circuit switched service is deactivated and a second list of SCFs to inform if the subscriber's packet switched service is deactivated. Alternatively the HLR may contain one list of SCFs to inform with different flags depending on whether they should be informed on deactivation of the CS or PS services or both CS and PS services.

This invention is particularly applicable in networks where presence services and automatically initiated services are available. One example of a presence service is a service which allows a group of friends to determine whether they are each connected to the network, (MSN Messenger is an example of such a presence service on the internet). If a SCF is unaware that a subscriber has been deactivated it will continue to display to others within the group using the presence service that that subscriber is still active.

Automatically initiated services are those services which involve a call being invoked by someone other than the end user, for example, mobility services like traffic management messages and news alerts. These services may be provided by and/or invoked by the SCFs. The CAMEL standard phase 4 introduces the ability for the SCF to invoke a call to the subscriber. The call may be invoked on the basis of the location of the end user, the time of day or some other external event.

The discussion above in relation to FIGS. 2 and 3 is related to subscriber deactivation however, it will be apparent to a skilled reader that it is equally applicable to situation of subscriber deletion or activation.

The term ‘activation’ is used herein to refer to the situation when the subscriber status is changed such that they are now able to make and receive calls. This may follow the rectification of the situation which led to a subscriber being deactivated or deleted, for example, payment of outstanding bills, or subscription to new services.

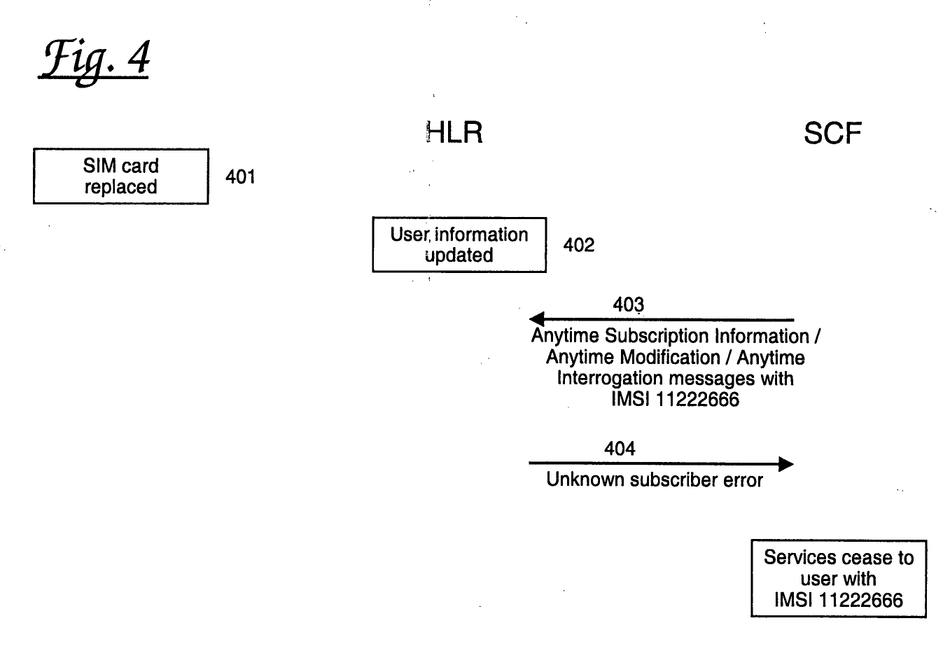

A second example of the present invention is shown with reference to FIGS. 4 to 6.

In order that the SCF can provide a service to an end user, the end user must be referenced by means of a unique identifier number. This is commonly the IMSI (International Mobile Subscriber Identity) or MSISDN (Mobile Subscriber International Subscriber Directory Number). The IMSI is associated with the SIM (Subscriber Identity Module) card belonging to the subscriber and located with the end user network element (e.g. mobile phone) and the MSISDN is the telephone number. However, as it is possible for a subscriber to have multiple profiles with multiple MSISDNs (e.g. one MSISDN or telephone number for personal calls and one MSISDN or telephone number for business calls both associated with the same mobile phone, but perhaps having different ring tones), the only unique identifier is the IMSI.

When a user replaces their SIM card 401, for example if their phone is stolen and then replaced or their SIM card is damaged or when a user upgrades from a 2G mobile service to a 3G mobile service, their IMSI is changed and the user information is accordingly updated 402 on the HLR, as shown in the schematic message flow in FIG. 4. Subsequently when the SCF attempts to request or update information relating to a user from the HLR addressing the HLR by means of the IMSI, the HLR will not recognise the old IMSI and will respond with an absent subscriber error 404. As a result of this the SCF may cease to provide services to the user with that IMSI, the subscriber will not receive services to which he is entitled and there will be unnecessary signalling across the network.

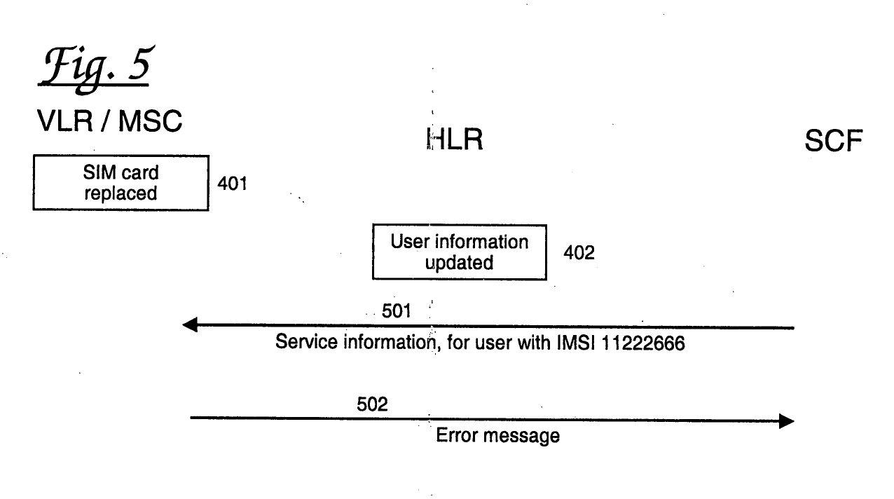

Alternatively as shown in FIG. 5, a SCF may try to initiate service provision to a user referring to them by their IMSI 501. This may be an automatically initiated service as described above. If the user has replaced their SIM card then the VLR will not recognise the IMSI which is used by the SCF and the VLR will return an error message 502.

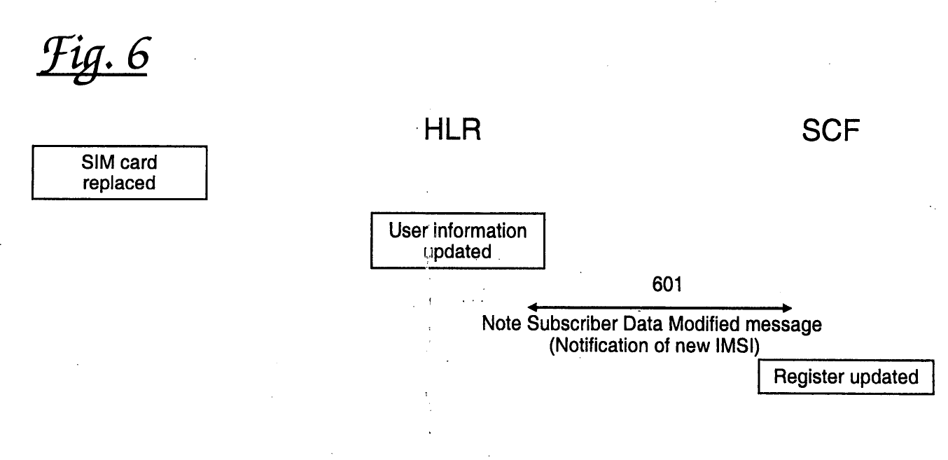

In order that service provision to a subscriber is not interrupted on replacement of a SIM card the HLR must inform the SCFs of the new IMSI 601, as shown in FIG. 6. This enables the SCFs to update their registers and continue to provide services by stopping services using the old IMSI and instead referencing them by the new IMSI. The operator can again determine which SCFs to notify of the new IMSI. This may be a subset of SCFs according to a predetermined list (or could be all of them).

Alternatively the HLR may decide to notify or not SCFs based on set of rules, e.g. SCFs throughout the network or throughout the country.

Further examples of this invention include when the HLR implements suppression or screening. Again, the HLR may notify a sub-set of the SCFs (or all SCFs) of the screening profile for the subscribers current location along with any service suppression information if present for a particular user. Having been notified, the SCF can update its user information and not activate those services for the relevant user or users.

According to this example, when a subscriber locates at a VLR/MSC and/or SGSN the HLR sends the predetermined set of SCFs (as described earlier) the screening profile for the subscriber's current location. In addition to the screening profile, service suppression information may also be included. If the suppression level for a service is changed whilst the subscriber is located, the HLR may inform the predetermined set of SCFs of this change. This ensures that the SCF always has the correct subscriber status information.

An advantage of informing the SCF that a service is either screened, suppressed or both, it that it provides the SCF with the ability to prevent activation of a service which the subscriber will not be able to utilise (as it is screened or suppressed), hence reducing the amount of unnecessary signalling.

With knowledge of the subscribers current locations screening profile along with the subscribers suppression information, the SCF will also be able to identify scenarios where the activation or change in suppression of a particular service may result in the subscriber being barred from all services (for example being blocked from making or receiving calls).

Screening allows operators to prevent service information being sent to a single or group of nodes (where the node may be a VLR/MSC or SGSN). The reasons for doing so may be that the roaming partner's network may not support the service level required (for example they may not support the required phase of CAMEL). Where a network doesn't support the service level required, the operator may find that they may not be able to bill for specific services or that the user will not be able to access a specific service when roaming. For example, in the case where the roaming partner doesn't support the required phase of CAMEL, screening may impose barring to prevent outgoing calls as CAMEL (specifically O-CSI=Originating CAMEL Subscription Information) may be used to provide the prepaid service and without it the operator wouldn't be able to bill the subscriber correctly. Here the operator may want to prevent the sending of CAMEL information (as it's not supported) and bar outgoing calls. Other scenarios include when an operator simply prevents service information being sent as it is not supported by the roaming partner.

This invention provides a mechanism which can prevent the SCF from activating (or un-suppressing) a CSI that is not supported and hence may lead to barring for outgoing calls. What the SCF can or can't activate/deactivate is governed by the agreement with the operator.

Suppression of services may occur for a subscriber, for example, according to the service agreement that the subscriber has. For example, suppression allows the operator to permit a subscriber to access a particular service whilst in the UK, but to prevent the subscriber from accessing that service when roaming abroad. A second subscriber may have agreed a different level of service with the operator and may be allowed to access that same service from abroad. Without notification of the suppression to the SCF, the SCF will try and activate services which will result in unnecessary signalling.

It can be seen from the examples given above that the change in network user status information may be the result of action or inaction on the part of the user (e.g. subscribing or cancelling a service or failure to pay a bill or changing location) but may also be due to network aspects (e.g. the inability of a network to support a particular service or CSI or phase).

‘Phase’ is the term used for the different releases of CAMEL e.g. phase 1, phase 2 and phase 3. Different CSIs may be used to implement different network services and these may change (e.g. be enhanced) with the release of CAMEL.

FIG. 7 shows an example of a message for signalling between the HLR and the SCF according to the present invention. The message shown is an enhanced ‘Note Subscriber Data Modified’ (NSDM) message which relates specifically to the CAMEL standard. This is also referred to as a ‘Note Subscriber Data Changed’ (NSDC) message. This message is sent by the HLR to one or more SCFs according to the lists or rules as described above.

The lists in the HLR may include a ‘Notification to CSE’ (CAMEL Service Environment) indication that determines whether a change to the subscription activation state results in the HLR sending a NSDM message to each SCF in the associated SCF list.

The message shown in FIG. 7 includes the enhancement 701 for implementation of the activation and deactivation notification and enhancement 702 for notification of a replacement IMSI. Corresponding enhancements could be included for screening and suppression, as described above. The screening and suppression enhancements may include flags for each separate CSI and phase.

The NDSM message shown in FIG. 7 may be triggered in the standard way defined in the CAMEL 23.078 specification “Procedure CAMEL_NDSC_HLR (sheet 1)” as shown in FIG. 8.

The message in FIG. 7 is shown by way of example only and this invention is applicable to standards other than CAMEL and to communications networks which are other than wireless cellular networks.

It will be understood that the above description of preferred embodiments is given by way of example only and that various modifications may be made by those skilled in the art without departing from the spirit and scope of the invention.

1. A method of intelligent network service provision by a first network element, comprising the steps of:
Storing network user status information at said first network element;
Receiving at the first network element a message from a second network element, said message associated with a change in network user status information;
Updating said stored information; and
Providing services to said network user dependant on said network user status information.

2. A method according to claim 1, further comprising the step of:
at said second network element, sending a message to each of a predetermined set of network elements, said message associated with a change in network user status information,
wherein said predetermined set includes said first network element.

3. A method according to claim 2, further comprising the steps of:
at said second network element, selecting said predetermined set of network elements according to the change in network user status information.

4. A method according to claim 1, wherein the change in network user status information is one of user activated, user deactivated, user deleted, user identifier code updated, user service screened and user service suppressed.

5. A method according to claim 4, wherein said user identifier code is an international mobile subscriber identity.

6. A method according to claim 1, wherein the first and second network elements are wireless network elements.

7. A method according to claim 1, wherein the first network element is a service control function.

8. A method according to claim 1, wherein the second network element is a home location register.

9. A computer program for performing the method according to claim 1.

10. A computer program according to claim 9 stored in machine readable form.

11. A computer program according to claim 9 on a storage medium.

12. A method of sharing network user status information in a communications network, said method comprising the steps of:
storing network user status information at a first network element; and
sending a message to each of a predetermined set of network elements, said message associated with a change in network user status information.

13. A method according to claim 12, wherein each of said predetermined set of network elements are arranged to provide services to network users.

14. A method according to claim 12, further comprising the step of:
selecting said predetermined set of network elements according to the change in network user status information.

15. A computer program for performing the method according to claim 12.

16. A computer program according to claim 15 stored in machine readable form.

17. A computer program according to claim 15 on a storage medium.

18. A service providing network element comprising:
a memory arranged to store network user status information;
a receiver arranged to receive a message from a second network element, said message associated with a change in network user status information;
a processor arranged to read said message and update said network user status information stored in said memory; and
a transmitter arranged to provide services to a network user dependent on said network user status information.

19. A service providing network element according to claim 12, wherein said services are intelligent network services.

20. A service providing network element according to claim 12, said memory comprising a database.

21. A network element comprising:
a memory arranged to store network user status information; and
a transmitter arranged to send a message to each of a predetermined set of service providing network elements, said message associated with a change in network user status information.

22. A network element according to claim 21 comprising:
a selector arranged to select said predetermined set of service providing network elements according to said change in network user status information.

23. A communications network comprising:
a service providing network element according to claim 18; and
a network element according to claim 21.

24. A communications network according to claim 23, wherein said network is a wireless network.

25. A communications network according to claim 24, wherein said network is a cellular mobile network.
